(19) United States
(12) Patent Application Publication
(10) Pub. No.: US 2025/0172346 A1
(43) Pub. Date: May 29, 2025

(54) PLATE-TYPE HEAT EXCHANGER

(71) Applicant: HS R & A Co., Ltd., Yangsan-si (KR)

(72) Inventors: Jae Won SIM, Yangsan-si (KR); Jae Hyeok CHOI, Yangsan-si (KR); Guk Hyun KIM, Yangsan-si (KR); Young Jun KIM, Yangsan-si (KR); Kwon Sik HWANG, Yangsan-si (KR); Seung Hyo LEE, Yangsan-si (KR); Youn Kyou KIM, Yangsan-si (KR)

(73) Assignee: HS R & A Co., Ltd., Yangsan-si (KR)

(21) Appl. No.: 18/543,028

(22) Filed: Dec. 18, 2023

(30) Foreign Application Priority Data
Nov. 28, 2023 (KR) 10-2023-0168500

(51) Int. Cl. F28D 9/00; B60H 1/00

(52) U.S. Cl. CPC F28D 9/0056; F28D 9/005; B60H 1/00342

(57) ABSTRACT

A plate-type heat exchanger that performs heat exchange between a first fluid and a second fluid and includes a main body plate stack including a plurality of main body plates stacked on one another, and a plurality of heat exchange flow paths defined between the stacked main body plates and configured to allow the first or second fluid to flow therethrough, an upper plate coupled to the main body plate stack in a first direction, and a lower plate coupled to the main body plate stack in a second direction opposite to the first direction. The main body plate may include a plurality of elongated protruding portions each having a shape protruding from a surface of the main body plate and extending in a direction at least partially coincident with a direction in which the first or second fluid flows in the heat exchange flow path.

### CROSS REFERENCE TO RELATED APPLICATION

This application claims the priority of Korean Patent Application No. 10-2023-0168500 filed on Nov. 28, 2023, in the Korean Intellectual Property Office, the disclosure of which is incorporated herein by reference.

### BACKGROUND OF THE INVENTION

### Field of the Invention

The present disclosure relates to a cooling system, and more particularly, to a plate-type heat exchanger, in which different refrigerants are introduced into the plate-type heat exchanger and exchange heat with each other.

### Description of the Related Art

A vehicle may include an interior cooling system capable of maintaining a comfortable interior temperature by maintaining an appropriate temperature in a vehicle interior regardless of a change in outside temperature. In addition, the vehicle (e.g., an electric vehicle or a hybrid vehicle) may include a battery cooling system capable of ensuring performance of a battery by maintaining an appropriate temperature of the battery, the performance of which is changed as the temperature changes.

For example, the cooling system may include a compressor configured to compress a gaseous refrigerant, a condenser configured to condense the compressed refrigerant into a liquid refrigerant by allowing the compressed refrigerant to exchange heat with the surrounding environment, an expansion valve configured to depressurize the condensed refrigerant, a heat exchanger configured to allow the expanded refrigerant to exchange heat with the surrounding environment, and an evaporator configured to vaporize the cooled refrigerant. The refrigerant may be supercooled by exchanging heat with a heat reservoir such as a coolant while passing through the heat exchanger.

Because a cooling capacity of the cooling system is ultimately limited by a heat dissipation capacity of the heat exchanger, a sufficient heat dissipation capacity of the heat exchanger needs to be ensured to implement an appropriate operation of the cooling system. To this end, a heat exchange area of the heat exchanger needs to be increased. However, in case that the heat exchanger has an excessive size, it may not be easy to configure a layout in an engine room of the vehicle.

### SUMMARY OF THE INVENTION

A plate-type heat exchanger may be used to increase a heat exchange area under a condition in which the size of the heat exchanger is limited. The plate-type heat exchanger is configured such that a plurality of plates is stacked so that heat exchange flow paths are defined between the plates, and a first fluid (e.g., a refrigerant in a cooling system) and a second fluid (e.g., a vehicle coolant) respectively flow through even-numbered heat exchange flow paths and odd-numbered heat exchange flow paths. A plurality of cooling fins may be disposed in the heat exchange flow paths of the plate-type heat exchanger in order to increase the heat exchange area. However, in the plate-type heat exchanger, in case that a heat dissipation area is increased to increase the heat dissipation capacity, there is concern that a pressure loss is increased by resistance of the cooling fins.

The present disclosure has been made in an effort to solve the above-mentioned problem, and an object of the present disclosure is to provide a plate-type heat exchanger, in which an internal structure of the plate-type heat exchanger is improved, which ensures sufficient heat exchange performance and makes it easy to configure a layout in an engine room, and a cooling system for a vehicle including the same.

In order to achieve the above-mentioned object, a plate-type heat exchanger according to various embodiments of the present disclosure may be a plate-type heat exchanger that performs heat exchange between a first fluid and a second fluid and includes a main body plate stack including a plurality of main body plates stacked on one another, and a plurality of heat exchange flow paths defined between the stacked main body plates and configured to allow the first or second fluid to flow therethrough, an upper plate coupled to the main body plate stack in a first direction, and a lower plate coupled to the main body plate stack in a second direction opposite to the first direction. The main body plate may include a plurality of elongated protruding portions each having a shape protruding from a surface of the main body plate and extending in a direction at least partially coincident with a direction in which the first or second fluid flows in the heat exchange flow path.

In various embodiments, the elongated protruding portions may be oriented in the direction in which the first or second fluid flows in the heat exchange flow path.

In various embodiments, the main body plate may include an inflow hole formed through the surface of the main body plate so that the first or second fluid is introduced into the heat exchange flow path, and an outflow hole formed through the surface of the main body plate so that the first or second fluid is discharged from the heat exchange flow path. The main body plate may further include a partition wall positioned between the inflow hole and the outflow hole and configured to partially divide the heat exchange flow path.

In various embodiments, the partition wall may be formed in parallel with any one side of the main body plate and have a length equal to or larger than 60% of a length of one side.

In various embodiments, the partition wall may include: one end positioned at an edge of the main body plate; and the other end positioned opposite to one end and positioned to be relatively closer to the inside of the main body plate than the edge of the main body plate.

In various embodiments, the partition wall may include a round portion positioned at the other end and having a rounded shape having a radius of curvature larger than a width of the partition wall.

In various embodiments, the round portion may be positioned at the other end and biased toward the outflow hole.

In various embodiments, the heat exchange flow path may include: a first region positioned in a direction in which the inflow hole is positioned in a region defined by the partition wall; a second region positioned in a direction in which the outflow hole is positioned in a region defined by the partition wall; and a third region that is a region that is not defined by the partition wall. In various embodiments, the main body plate may be configured such that the first or second fluid flows from the first region to the second region via the third region.

In various embodiments, the partition wall may be disposed such that the first region is smaller than the second region.

In various embodiments, the elongated protruding portions may be disposed so that a velocity of the first or second fluid flowing in the second region is lower than a velocity of the first or second fluid flowing in the first region.

In various embodiments, the elongated protruding portions may be symmetrically disposed in the first region so that intervals between the elongated protruding portions gradually decrease in the direction in which the first or second fluid flows. In various embodiments, the elongated protruding portions may be symmetrically disposed in the second region so that intervals between the elongated protruding portions gradually increase in the direction in which the first or second fluid flows.

In various embodiments, the first and second regions may each include the elongated protruding portions disposed in parallel with the partition wall, and the third region may include the elongated protruding portions disposed obliquely with respect to the partition wall.

In various embodiments, the main body plate may further include a plurality of auxiliary protruding portions protruding from the surface of the main body plate toward the heat exchange flow path.

In various embodiments, a thickness of the heat exchange flow path may be 1 to 6 times a thickness of each of the plurality of main body plates.

A plate-type heat exchanger according to other embodiments of the present disclosure may be a plate-type heat exchanger that performs heat exchange between a first fluid and a second fluid and includes a main body plate stack including a plurality of main body plates stacked on one another, and a plurality of heat exchange flow paths defined between the stacked main body plates and configured to allow the first or second fluid to flow therethrough, an upper plate coupled to the main body plate stack in a first direction, and a lower plate coupled to the main body plate stack in a second direction opposite to the first direction. The main body plate may include a plurality of elongated protruding portions each having a shape protruding from a surface of the main body plate and extending in an oblique direction with respect to a direction in which the first or second fluid flows in the heat exchange flow path.

In various embodiments, the main body plate may include an inflow hole formed through the surface of the main body plate so that the first or second fluid is introduced into the heat exchange flow path, and an outflow hole formed through the surface of the main body plate so that the first or second fluid is discharged from the heat exchange flow path. The main body plate may further include a partition wall positioned between the inflow hole and the outflow hole and configured to partially divide the heat exchange flow path.

In various embodiments, the heat exchange flow path may include: a first region positioned in a direction in which the inflow hole is positioned in a region defined by the partition wall; a second region positioned in a direction in which the outflow hole is positioned in a region defined by the partition wall; and a third region that is a region that is not defined by the partition wall. In various embodiments, the main body plate may be configured such that the first or second fluid flows from the first region to the second region via the third region.

In various embodiments, the elongated protruding portions may be symmetrically disposed in the first region so that intervals between the elongated protruding portions gradually decrease in the direction in which the first or second fluid flows, and the elongated protruding portions may be symmetrically disposed in the second region so that intervals between the elongated protruding portions gradually increase in the direction in which the first or second fluid flows.

According to the plate-type heat exchanger according to the present disclosure, the major axis direction of the extension cooling fin is oriented at least partially in parallel with the flow of the fluid, thereby increasing the heat exchange area and improving the usability.

In addition, according to the plate-type heat exchanger and the cooling system for a vehicle including the same according to the present disclosure, the height of the low-temperature, low-pressure plate, along which the low-temperature, low-pressure gaseous refrigerant flows, is different from the height of the high-temperature, high-pressure plate along which the high-temperature, high-pressure liquid refrigerant flows, thereby reducing the size and volume of the plate-type heat exchanger as much as possible.

In addition, according to the plate-type heat exchanger and the cooling system for a vehicle including the same according to the present disclosure, the first support protrusion and the second support protrusion are provided on the high-temperature, high-pressure plate and the low-temperature, low-pressure plate, thereby preventing deformation of the plates as much as possible during the brazing process.

### BRIEF DESCRIPTION OF THE DRAWINGS

FIG. 1A is a perspective view illustrating a plate-type heat exchanger according to various embodiments of the present disclosure.

FIG. 1B is an exploded perspective view illustrating a main body plate stack of the plate-type heat exchanger according to various embodiments of the present disclosure.

FIG. 1C is an enlarged cross-sectional view illustrating the plate-type heat exchanger according to various embodiments of the present disclosure.

FIG. 2A is a perspective view illustrating a main body plate according to various embodiments.

FIGS. 2B and 2C are top plan views illustrating the main body plate according to various embodiments.

FIG. 3A is a perspective view illustrating the main body plate according to various embodiments of the present disclosure.

FIG. 3B is a top plan view illustrating the main body plate according to various embodiments of the present disclosure.

FIG. 4A is a perspective view illustrating the main body plate according to various embodiments of the present disclosure.

FIG. 4B is a top plan view illustrating the main body plate according to various embodiments of the present disclosure.

### DETAILED DESCRIPTION OF THE INVENTION

Hereinafter, exemplary embodiments of the present disclosure will be described in detail with reference to the accompanying drawings.

Embodiments of the present disclosure are provided to more completely explain the present disclosure to those skilled in the art. The following embodiments may be modified in various forms, and the scope of the present disclosure is not limited to the following embodiments. The embodiments are provided to make the present disclosure more thorough and complete, and to completely convey the spirit of the present disclosure to those skilled in the art. Therefore, in the present specification, a description of publicly-known technologies, which may obscure a description of a subject matter of the present disclosure, may be at least partially omitted.

In addition, in the drawings, a thickness or size of each layer may be exaggerated for the convenience and clarity of description. In the drawings, the same reference numerals refer to the same elements. The term “and/or” used in the present specification includes any one, one or more, or all the combinations of listed related items.

The terms used in the present specification are for explaining the particular embodiments, not for limiting the present disclosure. The singular expressions used in the present specification may include the plural expressions unless the context clearly dictates otherwise. The terms “comprise (include)” and/or “comprising (including)” used in the present specification are intended to specify the presence of the mentioned shapes, numbers, steps, operations, members, elements, and/or groups thereof, but do not exclude presence or addition of one or more other shapes, numbers, steps, operations, members, elements, and/or groups thereof.

In the present specification, the terms such as “first” and “second” may be used to describe various members, components, regions, and/or parts, but it is apparent that these members, components, regions, and/or parts should not be limited by the terms. These terms are used only to distinguish one member, one component, one region, or one part from another region or another part. Therefore, a first member, a first component, a first region, or a first part, which will be described below in detail, may refer to a second member, a second component, a second region, or a second part without departing from the teachings of the present disclosure.

In addition, in case that a layer is formed or disposed on another layer, an intermediate layer may be formed or disposed between these layers. Similarly, even in case that a material is disposed adjacent to another material, an intermediate material may be present between these materials. On the contrary, in case that a layer or material is formed or disposed “immediately” or “directly” on another layer or material or provided to be “immediately” or “directly” adjacent to or in contact with another layer or material, it should be understood that no intermediate material or layer is present between these materials or layers.

Hereinafter, the embodiments of the present disclosure will be described with reference to the drawings that schematically illustrate ideal embodiments of the present disclosure. For example, in the drawings, sizes and shapes of members may be exaggerated for convenience of description and clarity, and variations of the illustrated shapes may be expected when the members are actually implemented. Therefore, it should not be interpreted that the embodiments of the present disclosure are limited to particular shapes of regions illustrated in the present specification.

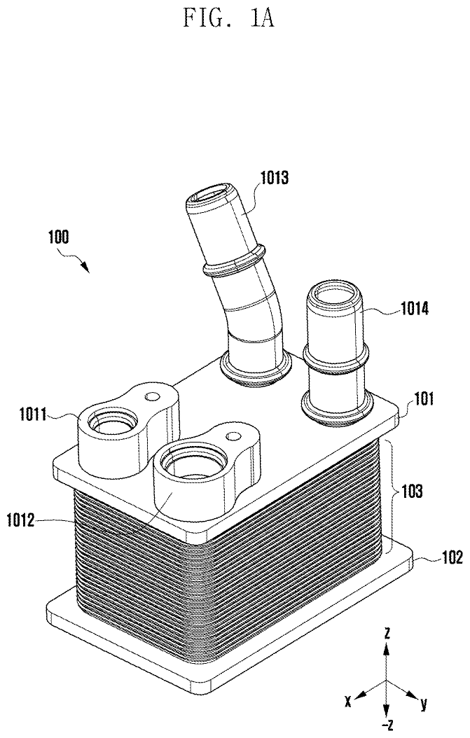

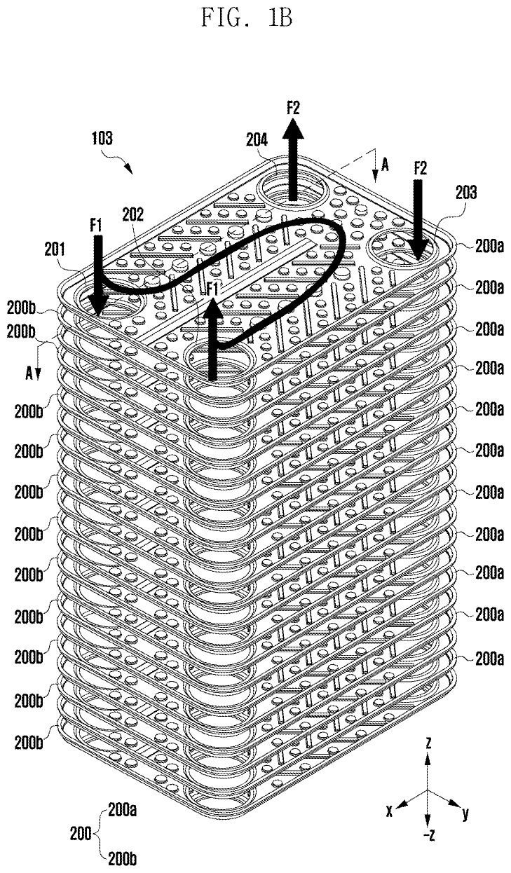

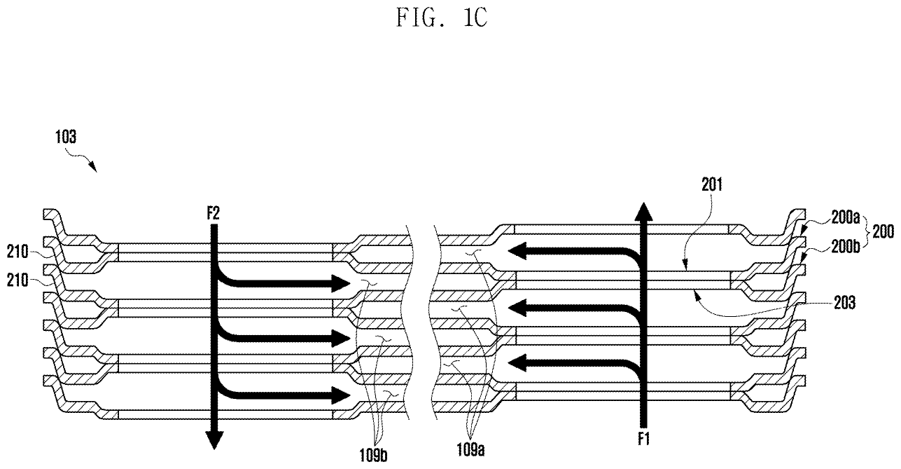

FIG. 1A is a perspective view illustrating a plate-type heat exchanger 100 according to various embodiments of the present disclosure.

FIG. 1B is an exploded perspective view illustrating a main body plate stack 103 of the plate-type heat exchanger 100 according to various embodiments of the present disclosure.

FIG. 1C is an enlarged cross-sectional view illustrating the plate-type heat exchanger 100 according to various embodiments of the present disclosure.

FIG. 1C is a cross-sectional view taken along direction A-A in FIG. 1A.

With reference to FIGS. 1A to 1C, the plate-type heat exchanger 100 according to various embodiments of the present disclosure may include the main body plate stack 103, an upper plate 101, and a lower plate 102.

In various embodiments, the main body plate stack 103 may be a stack in which a plurality of main body plates 200 (e.g., one or more first main body plates 200a and one or more second main body plates 200b) is stacked so that a plurality of heat exchange flow paths 109 (e.g., one or more first heat exchange flow paths 109a and one or more second heat exchange flow paths 109b) is formed therein.

In various embodiments, the upper plate 101 may be a member positioned in a first direction (e.g., a z-direction) with respect to the main body plate stack 103, configured to close an uppermost end of the main body plate stack 103, and having inlet and outlet ports (e.g., a first inlet port 1011, a first outlet port 1012, a second inlet port 1013, and a second outlet port 1014) through which a fluid is introduced and discharged.

In various embodiments, the lower plate 102 may be a member positioned in a second direction (e.g., a −z-direction) with respect to the main body plate stack 103 and configured to close a lowermost end of the main body plate stack 103. Although not illustrated, in some embodiments, some of the inlet and outlet ports (e.g., the second inlet port and the second outlet port) may be provided in the lower plate 102.

In various embodiments, the main body plates 200 may be plates stacked at predetermined intervals D1 so that the heat exchange flow paths 109 are defined between the plurality of main body plates 200. A material of the main body plate 200 may include a metallic material, e.g., aluminum, which is excellent in strength and thermal conductivity, or an alloy containing aluminum.

In various embodiments, the predetermined interval D1 between the plurality of main body plates 200 may be 1 to 6 times a thickness T1 of the main body plate 200. Particularly, the interval D1 between the main body plates 200 may be 2.5 times the thickness T1 of the main body plate 200.

For example, the thickness T1 of the main body plate 200 may be 0.3 to 0.7 mm, and the predetermined interval D1 between the main body plates 200 may be 0.75 to 1.75 mm. When the interval D1 between the main body plates 200 is smaller than the range, the flow resistance of the fluid increases, which causes an excessive pressure loss. When the interval D1 between the main body plates 200 is larger than the range, a heat exchange area decreases relative to the size of the plate-type heat exchanger 100, which degrades the performance of the plate-type heat exchanger 100. In addition, when the thickness T1 of the main body plate 200 is smaller than the range, there is a great risk that the main body plate 200 bursts or tears when the main body plate 200 is processed. When the thickness T1 of the main body plate 200 is larger than the range, thermal resistance increases in a thickness direction of the main body plate 200, which degrades the performance of the plate-type heat exchanger 100.

In various embodiments, the main body plates 200 may each include an inflow hole 201 and an outflow hole 202 formed to allow the first or second fluid to enter and exit the first heat exchange flow path 109a or the second heat exchange flow path 109b. In addition, the main body plates 200 may each include passing holes 203 and 204 formed at positions corresponding to the inflow hole 201 and the outflow hole 202 of another adjacent main body plate 200 so that the first or second fluid may flow to the heat exchange flow path 109 of another adjacent main body plate 200. For example, with reference to FIG. 1C, the main body plate stack 103 may include the first main body plates 200a and the second main body plates 200b alternately stacked. In various embodiments, the second main body plate 200b may have a shape identical to a shape made by rotating the first main body plate 200a by 180 degrees on a plane (e.g., an x-y plane).

The first passing hole 203 of the second main body plate 200b is formed at a position corresponding to the inflow hole 201 of the first main body plate 200a, and an outer peripheral portion of the inflow hole 201 of the first main body plate 200a and an outer peripheral portion of the first passing hole 203 of the second main body plate 200b are joined to each other, such that the first fluid having passed through the passing holes 203 and 204 of the second main body plate 200b may be introduced into the first heat exchange flow path 109a between the first main body plate 200a and the second main body plate 200b through the inflow hole 201 of the first main body plate 200a. In various embodiments, the main body plate 200 may include a rim wall 210 formed on an outer peripheral portion of the main body plate 200 to close the main body plate stack 103 in transverse directions (e.g., an x-direction and a y-direction). The rim walls 210 may define gaps between the plurality of main body plates 200 so that the heat exchange flow paths 109 may be defined when the main body plates 200 are stacked. For example, the rim wall 210 of the first main body plate 200a may support the second main body plate 200b, such that the first heat exchange flow path 109a may be defined between the first main body plate 200a and the second main body plate 200b. In addition, the rim wall 210 of the second main body plate 200b may define the second heat exchange flow path 109b between the second main body plate 200b and the first main body plate 200a.

In various embodiments, the rim walls 210 of the plurality of main body plates 200 may be joined to one another to prevent a leak of the fluid and close the heat exchange flow paths 109. In the present specification, the ‘joining’ may include means or methods, such as welding, soldering, brazing, and/or bonding, for coupling members.

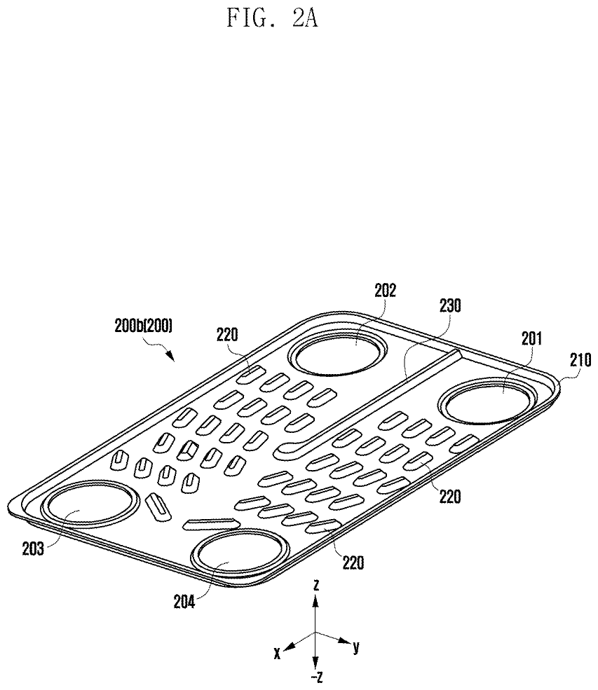

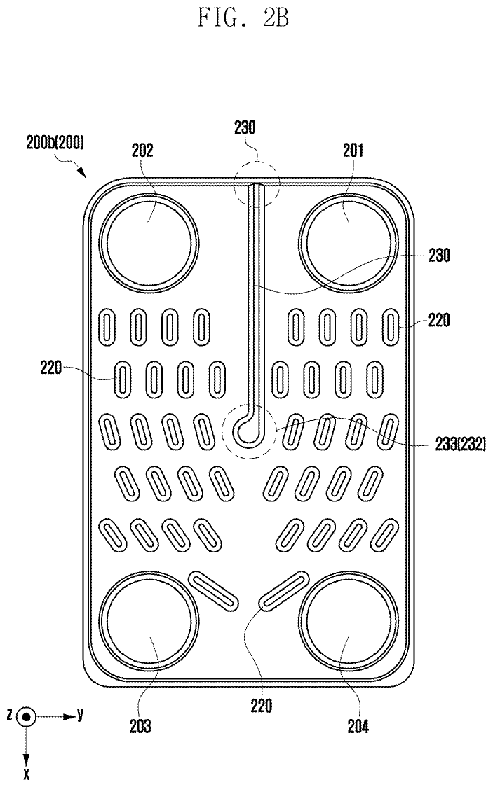

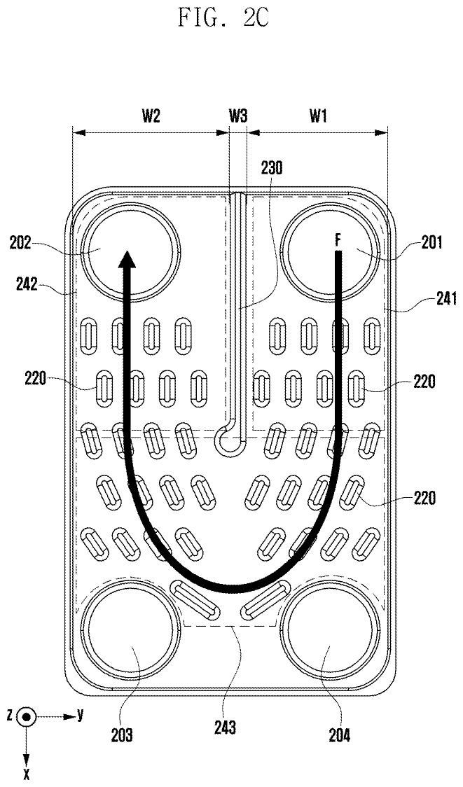

FIG. 2A is a perspective view illustrating the main body plate 200 according to various embodiments.

FIGS. 2B and 2C are top plan views illustrating the main body plate 200 according to various embodiments.

With reference to FIGS. 2A to 2C, the plate-type heat exchanger 100 may include elongated protruding portions 220. The elongated protruding portion 220 may be a portion protruding from a surface of the main body plate 200 toward the inside of the heat exchange flow path 109. When viewed in the first direction (z-direction), the elongated protruding portion 220 may be a portion having a shape (e.g., a rectangular shape, an elliptical shape, a trapezoidal shape, a stadium shape, or the like) extending in a direction parallel to the surface of the main body plate 200.

In various embodiments, as illustrated in FIG. 2A, the elongated protruding portion 220 may protrude in the first direction (e.g., the z-direction) that is the direction in which the rim wall 210 extends. In other embodiments, the elongated protruding portion 220 may protrude in the direction (e.g., the −z-direction) opposite to the first direction.

In various embodiments, the elongated protruding portion 220 may serve as a fin (e.g., a cooling fin) and/or a guide vane in the heat exchange flow path 109. For example, the elongated protruding portion 220 increases a surface area of the main body plate 200, which increases a heat exchange area between the first and second fluids, thereby increasing a heat exchange capacity of the plate-type heat exchanger 100. In addition, the elongated protruding portion 220 may guide a flow of the first or second fluid in the heat exchange flow path 109. In various embodiments, the elongated protruding portion 220 may be disposed at least partially in parallel with a direction F in which the fluid flows in the heat exchange flow path 109.

In various embodiments, the main body plate 200 may include a partition wall 230.

The partition wall 230 may be a portion protruding from the surface of the main body plate 200 to partially divide the heat exchange flow path 109. In various embodiments, the partition wall 230 may be positioned between the inflow hole 201 and the outflow hole 202 of the main body plate 200. The partition wall 230 may extend from a peripheral portion (e.g., the rim wall 210) of the main body plate 200 toward the inside of the main body plate 200. For example, one end 231 of the partition wall 230 may be positioned on the peripheral portion of the main body plate 200, and the other end 232 of the partition wall 230 may be positioned in a region closer to a center of the main body plate 200 than the peripheral portion of the main body plate 200. In various embodiments, the partition wall 230 may be formed in parallel with one side (e.g., a long side) of the main body plate 200. In various embodiments, a length L2 of the partition wall 230 may be equal to or larger than 60% of a length L1 of one side (e.g., the long side) of the main body plate 200.

With reference to FIGS. 2B and 2C, the fluid, which is introduced into the heat exchange flow path 109 through the inflow hole 201, may flow from a first region 241, pass through a third region 243, and be discharged through the outflow hole 202 in a second region 242. In various embodiments, the heat exchange flow path 109 may include the first region 241 that is a region in which the inflow hole 201 is positioned in the region defined by the main body plate 200, the second region 242 that is a region in which the outflow hole 202 is positioned in the region defined by the main body plate 200, and the third region 243 that is a region that is not defined by the main body plate 200. In various embodiments, the first and second regions 241 and 242 may each include the elongated protruding portions 220 disposed substantially in parallel with the partition wall 230, and the third region 243 may include the elongated protruding portions 220 disposed obliquely with respect to the partition wall 230. Angles of the elongated protruding portions 220 in the third region 243 with respect to the partition wall 230 may gradually increase as the distance from the inlet and outlet ports increases. For example, the plurality of elongated protruding portions 220 may be disposed to form a U-shaped fluid flow F when viewed in the first direction (z-direction).

In various embodiments, the partition wall 230 may asymmetrically divide the heat exchange flow path 109. For example, a width W1 of the first region 241 may be smaller than a width W2 of the second region 242. Because the first region 241 has a smaller width than the second region 242, a cross-sectional area of the flow path increases and a velocity decreases from the inlet port to the outlet port when the fluid passes through the heat exchange flow path 109, which makes it possible to at least partially compensate for a pressure loss that occurs when the fluid passes through the heat exchange flow path 109.

In various embodiments, the partition wall 230 may include a round portion 233 positioned at the other end 232, i.e., an end positioned inside the main body plate 200. The round portion 233 may be a portion of the partition wall 230 that is formed in a curved shape having a radius of curvature of a predetermined value or more, e.g., a radius of curvature larger than half a width W3 of the partition wall 230. The round portion 233 may prevent or suppress the occurrence of vortices caused by a rapid change in flow path at the distal end of the partition wall 230 when the fluid flows around the partition wall 230. In various embodiments, the round portion 233 may be positioned to be biased toward the second region 242, i.e., toward the outflow hole 202.

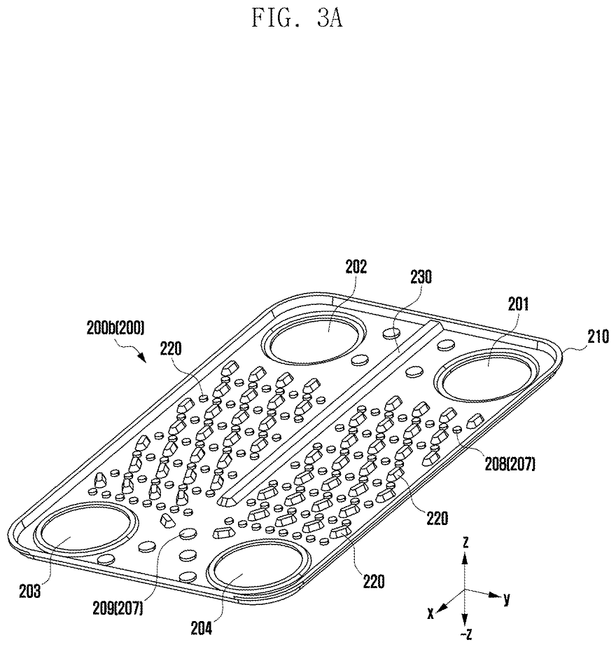

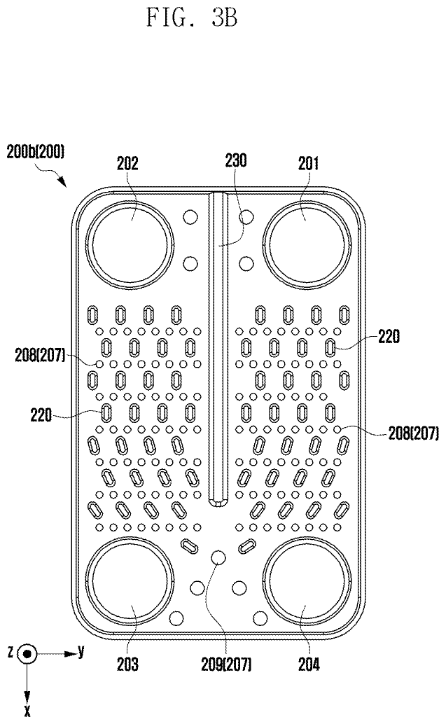

FIG. 3A is a perspective view illustrating the main body plate 200 according to various embodiments of the present disclosure.

FIG. 3B is a top plan view illustrating the main body plate 200 according to various embodiments of the present disclosure.

With reference to FIGS. 3A and 3B, the main body plate 200 according to various embodiments may include auxiliary protrusions 207. The auxiliary protrusion 207 may be a portion protruding from the surface of the main body plate 200. The auxiliary protrusion 207 may increase the surface area in the heat exchange flow path 109, thereby increasing the heat transfer capacity. For example, a shape of the auxiliary protrusion 207 may include a shape similar to a cylindrical shape. In some embodiments, a protruding height of the auxiliary protrusion 207 may be smaller than a height of the elongated protruding portion 220 in order to minimize the hindrance to the flow of the fluid in the heat exchange flow path 109. For example, the protruding height of the elongated protruding portion 220 may be 1.1 mm, and the height of the auxiliary protrusion 207 may be 0.5 mm.

In various embodiments, the auxiliary protrusions 207 may include first auxiliary protrusions 208, and second auxiliary protrusions 209 each having a larger size than the first auxiliary protrusion 208. The second auxiliary protrusions 209 may be disposed in a region in which a flow direction of the fluid is changed in the heat exchange flow path 109. For example, the second auxiliary protrusions 209 may be positioned in the third region 243 of the heat exchange flow path 109.

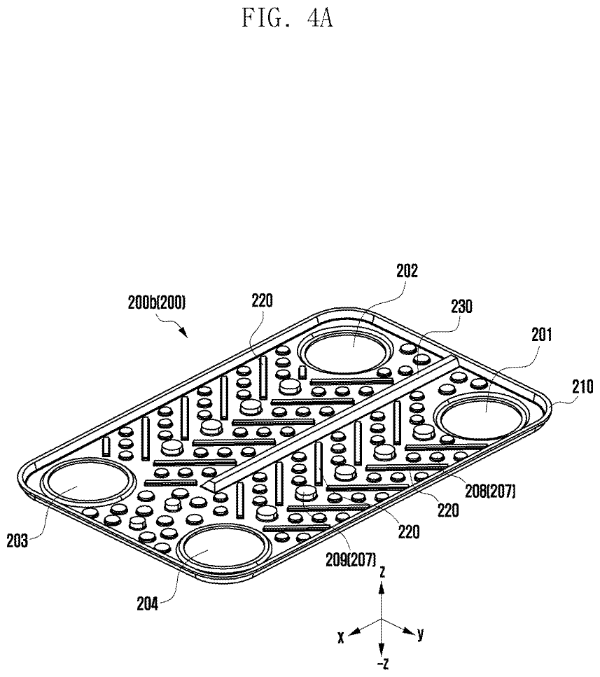

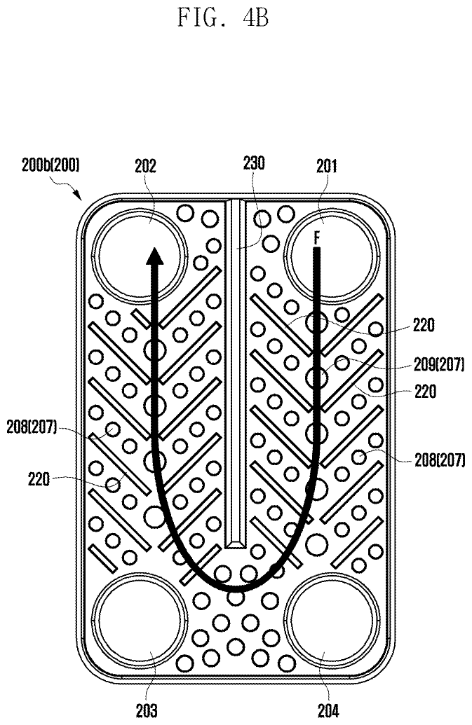

FIG. 4A is a perspective view illustrating the main body plate 200 according to various embodiments of the present disclosure.

FIG. 4B is a top plan view illustrating the main body plate 200 according to various embodiments of the present disclosure.

With reference to FIGS. 4A and 4B, in various embodiments, the plurality of elongated protruding portions 220 may be disposed to have a shape extending in an oblique direction with respect to the flow direction F of the fluid. For example, the plurality of elongated protruding portions 220 may be disposed to define wedge shapes or V shapes. The plurality of elongated protruding portions 220 may be disposed so that a vertex portion of the V shape is opened. In various embodiments, in the first region 241, the plurality of elongated protruding portions 220 may be disposed so that intervals between the elongated protruding portions 220 gradually decrease in the flow direction F of the fluid (e.g., the vertex portion of the V shape is directed in the flow direction F of fluid). In the second region 242, the plurality of elongated protruding portions 220 may be disposed so that intervals between the elongated protruding portions 220 gradually increase in the flow direction F of the fluid (e.g., the vertex portion of the V shape is directed in a direction opposite to the flow direction F of the fluid). The elongated protruding portions 220 in the first region 241 may allow the fluid to flow at a high velocity in the first region 241, and the elongated protruding portions 220 in the second region 242 may allow the fluid to flow at a low velocity in the second region 242. Therefore, the increase in fluid pressure, which is implemented by the decrease in velocity in the second region 242, may at least partially compensate for a pressure loss that occurs when the fluid introduced into the inlet port flows from the first region 241 to the second region 242 via the third region 243.

In various embodiments, the plurality of auxiliary protrusions 207 (e.g., the first auxiliary protrusions 208) of the main body plate 200 may be arranged in parallel with the elongated protruding portions 220 to reduce resistance against the flow of the fluid in the heat exchange flow path 109.

In various embodiments, the auxiliary protrusions 207 (e.g., the second auxiliary protrusions 209) may be provided inside the V shapes defined by the plurality of elongated protruding portions 220, and the auxiliary protrusions 207 (e.g., the second auxiliary protrusions 209) may be disposed adjacent to the vertex portions of the V shapes. Therefore, the auxiliary protrusion 207 may reduce a turbulent flow generated by the fluid passing through the vertex portion of the V shape and reduce a pressure loss caused by the turbulent flow.

The plate-type heat exchanger 100 according to various embodiments of the present disclosure is the plate-type heat exchanger 100 that performs the heat exchange between the first fluid and the second fluid. The plate-type heat exchanger 100 may include the main body plate stack 103 including the plurality of main body plates 200 stacked on one another, and the plurality of heat exchange flow paths 109 defined between the stacked main body plates 200 and configured to allow the first or second fluid to flow therethrough, the upper plate 101 coupled to the main body plate stack 103 in the first direction, and the lower plate 102 coupled to the main body plate stack 103 in the second direction opposite to the first direction. The main body plate 200 may include the plurality of elongated protruding portions 220 each having a shape protruding from the surface of the main body plate 200 toward the inside of the heat exchange flow path 109 and extending on the surface of the main body plate 200 in a direction at least partially coincident with the direction in which the first or second fluid flows.

In various embodiments, the main body plate 200 may include the inflow hole 201 formed through the surface of the main body plate 200 so that the first or second fluid is introduced into the heat exchange flow path 109, and the outflow hole 202 formed through the surface of the main body plate 200 so that the first or second fluid is discharged from the heat exchange flow path 109. The main body plate 200 may further include the partition wall 230 positioned between the inflow hole 201 and the outflow hole 202 and configured to partially divide the heat exchange flow path 109.

In various embodiments, the partition wall 230 may be formed in parallel with any one side of the main body plate 200 and have a length equal to or larger than 60% of the length of one side.

In various embodiments, the partition wall 230 may include one end 231 positioned at an edge of the main body plate 200, and the other end 232 positioned opposite to one end 231 and positioned to be relatively closer to the inside than the edge of the main body plate 200.

In various embodiments, the partition wall 230 may include the round portion 233 positioned at the other end 232 and having a rounded shape having a radius of curvature larger than half a width of the partition wall 230.

In various embodiments, the round portion 233 may be positioned at the other end 232 and biased toward the outflow hole 202.

In various embodiments, the heat exchange flow path 109 may include the first region 241 positioned in a direction in which the inflow hole 201 is positioned in the region defined by the partition wall 230, the second region 242 positioned in a direction in which the outflow hole 202 is positioned in the region defined by the partition wall 230, and the third region 243 that is the region that is not defined by the partition wall 230. The main body plate 200 may be configured such that the first or second fluid flows from the first region 241 to the second region 242 via the third region 243.

In various embodiments, the partition wall 230 may be disposed such that the first region 241 is smaller than the second region 242.

In various embodiments, the elongated protruding portions 220 may be disposed such that a velocity of the first or second fluid flowing in the second region 242 is lower than a velocity of the first or second fluid flowing in the first region 241.

In various embodiments, in the first region 241, the elongated protruding portions 220 may be symmetrically disposed so that the intervals between the elongated protruding portions 220 gradually decrease in the direction in which the first or second fluid flows. In the second region 242, the elongated protruding portions 220 may be symmetrically disposed so that the intervals between the elongated protruding portions 220 gradually increase in the direction in which the first or second fluid flows.

In various embodiments, the first region 241 and the second region 242 may each include the elongated protruding portions 220 disposed in parallel with the partition wall 230, and the third region 243 may include the elongated protruding portions 220 disposed obliquely with respect to the partition wall 230.

In various embodiments, the main body plate 200 may further include the plurality of auxiliary protruding portions protruding from the surface of the main body plate 200 toward the heat exchange flow path 109.

In various embodiments, a thickness of the heat exchange flow path 109 may be 1 to 6 times a thickness of each of the plurality of main body plates 200.

The plate-type heat exchanger 100 according to various embodiments of the present disclosure is the plate-type heat exchanger 100 that performs the heat exchange between the first fluid and the second fluid. The plate-type heat exchanger 100 may include the main body plate stack 103 including the plurality of main body plates 200 stacked on one another, and the plurality of heat exchange flow paths 109 defined between the stacked main body plates 200 and configured to allow the first or second fluid to flow therethrough, the upper plate 101 coupled to the main body plate stack 103 in the first direction, and the lower plate 102 coupled to the main body plate stack 103 in the second direction opposite to the first direction. The main body plate 200 may include the plurality of elongated protruding portions 220 each having a shape protruding from the surface of the main body plate 200 toward the inside of the heat exchange flow path 109 and extending on the surface of the main body plate 200 in an oblique direction with respect to the direction in which the first or second fluid flows.

In various embodiments, the main body plate 200 may include the inflow hole 201 formed through the surface of the main body plate 200 so that the first or second fluid is introduced into the heat exchange flow path 109, and the outflow hole 202 formed through the surface of the main body plate 200 so that the first or second fluid is discharged from the heat exchange flow path 109. The main body plate 200 may further include the partition wall 230 positioned between the inflow hole 201 and the outflow hole 202 and configured to partially divide the heat exchange flow path 109.

In various embodiments, the heat exchange flow path 109 may include the first region 241 positioned in a direction in which the inflow hole 201 is positioned in the region defined by the partition wall 230, the second region 242 positioned in a direction in which the outflow hole 202 is positioned in the region defined by the partition wall 230, and the third region 243 that is the region that is not defined by the partition wall 230. The main body plate 200 may be configured such that the first or second fluid flows from the first region 241 to the second region 242 via the third region 243.

In various embodiments, in the first region 241, the elongated protruding portions 220 may be symmetrically disposed so that the intervals between the elongated protruding portions 220 gradually decrease in the direction in which the first or second fluid flows. In the second region 242, the elongated protruding portions 220 may be symmetrically disposed so that the intervals between the elongated protruding portions 220 gradually increase in the direction in which the first or second fluid flows.

It is apparent to those skilled in the art that the constituent elements of the present disclosure described in the present specification and illustrated in the drawings may be combined with one another even in ways different from the way described in the present specification and illustrated in the drawings. For example, it is apparent to those skilled in the art that the configurations (e.g., the configuration in which the partition wall 230 is asymmetrically disposed so that the first region 241 has a smaller width than the second region 242 and the configuration in which the partition wall 230 includes the round portion 233 positioned at the other end 232 of the partition wall 230) illustrated in FIGS. 2A to 2B may be combined in FIGS. 3A to 4B.

Further, the embodiments disclosed in the present document disclosed in the present specification and illustrated in the drawings are provided as particular examples for easily explaining the technical contents according to the embodiment disclosed in the present document and helping understand the embodiment disclosed in the present document, but not intended to limit the scope of the embodiment disclosed in the present document. Accordingly, the scope of the various embodiments disclosed in the present document should be interpreted as including all alterations or modifications derived from the technical spirit of the various embodiments disclosed in the present document in addition to the embodiments disclosed herein.

### DESCRIPTION OF REFERENCE NUMERALS

100: Plate-type heat exchanger
101: Upper plate
102: Lower plate
103: Main body plate stack
200: Main body plate
220: Elongated protruding portion
230: Partition wall
207: Auxiliary protrusion

What is claimed is:

1. A plate-type heat exchanger, which performs heat exchange between a first fluid and a second fluid, the plate-type heat exchanger comprising:
a main body plate stack including a plurality of main body plates stacked on one another, and a plurality of heat exchange flow paths defined between the stacked main body plates and configured to allow the first or second fluid to flow therethrough;
an upper plate coupled to the main body plate stack in a first direction; and
a lower plate coupled to the main body plate stack in a second direction opposite to the first direction,
wherein the main body plate comprises a plurality of elongated protruding portions each having a shape protruding from a surface of the main body plate and extending in a direction at least partially coincident with a direction in which the first or second fluid flows in the heat exchange flow path.

2. The plate-type heat exchanger of claim 1, wherein the main body plate comprises:
an inflow hole formed through the surface of the main body plate so that the first or second fluid is introduced into the heat exchange flow path;
an outflow hole formed through the surface of the main body plate so that the first or second fluid is discharged from the heat exchange flow path; and
a partition wall positioned between the inflow hole and the outflow hole and configured to partially divide the heat exchange flow path.

3. The plate-type heat exchanger of claim 2, wherein the partition wall is formed in parallel with any one side of the main body plate and has a length equal to or larger than 60% of a length of one side.

4. The plate-type heat exchanger of claim 2, wherein the partition wall comprises:
one end positioned at an edge of the main body plate; and
the other end positioned opposite to one end and positioned to be relatively closer to the inside of the main body plate than the edge of the main body plate.

5. The plate-type heat exchanger of claim 4, wherein the partition wall comprises a round portion positioned at the other end and having a rounded shape having a radius of curvature larger than half a width of the partition wall.

6. The plate-type heat exchanger of claim 5, wherein the round portion is positioned at the other end and biased toward the outflow hole.

7. The plate-type heat exchanger of claim 2, wherein the heat exchange flow path comprises:
a first region positioned in a direction in which the inflow hole is positioned in a region defined by the partition wall;
a second region positioned in a direction in which the outflow hole is positioned in a region defined by the partition wall; and
a third region that is a region that is not defined by the partition wall, and
wherein the main body plate is configured such that the first or second fluid flows from the first region to the second region via the third region.

8. The plate-type heat exchanger of claim 7, wherein the partition wall is disposed such that the first region is smaller than the second region.

9. The plate-type heat exchanger of claim 7, wherein the elongated protruding portions are disposed so that a velocity of the first or second fluid flowing in the second region is lower than a velocity of the first or second fluid flowing in the first region.

10. The plate-type heat exchanger of claim 7, wherein the elongated protruding portions are symmetrically disposed in the first region so that intervals between the elongated protruding portions gradually decrease in the direction in which the first or second fluid flows, and
wherein the elongated protruding portions are symmetrically disposed in the second region so that intervals between the elongated protruding portions gradually increase in the direction in which the first or second fluid flows.

11. The plate-type heat exchanger of claim 7, wherein the first and second regions each include the elongated protruding portions disposed in parallel with the partition wall, and the third region includes the elongated protruding portions disposed obliquely with respect to the partition wall.

12. The plate-type heat exchanger of claim 1, wherein the main body plate further comprises a plurality of auxiliary protruding portions protruding from the surface of the main body plate toward the heat exchange flow path.

13. The plate-type heat exchanger of claim 1, wherein a thickness of the heat exchange flow path is 1 to 6 times a thickness of each of the plurality of main body plates.

14. A plate-type heat exchanger, which performs heat exchange between a first fluid and a second fluid, the plate-type heat exchanger comprising:
a main body plate stack including a plurality of main body plates stacked on one another, and a plurality of heat exchange flow paths defined between the stacked main body plates and configured to allow the first or second fluid to flow therethrough;
an upper plate coupled to the main body plate stack in a first direction; and
a lower plate coupled to the main body plate stack in a second direction opposite to the first direction,
wherein the main body plate comprises a plurality of elongated protruding portions each having a shape protruding from a surface of the main body plate and extending in an oblique direction with respect to a direction in which the first or second fluid flows in the heat exchange flow path.

15. The plate-type heat exchanger of claim 14, wherein the main body plate comprises:
an inflow hole formed through the surface of the main body plate so that the first or second fluid is introduced into the heat exchange flow path;
an outflow hole formed through the surface of the main body plate so that the first or second fluid is discharged from the heat exchange flow path; and
a partition wall positioned between the inflow hole and the outflow hole and configured to partially divide the heat exchange flow path,
wherein the heat exchange flow path comprises:
a first region positioned in a direction in which the inflow hole is positioned in a region defined by the partition wall;
a second region positioned in a direction in which the outflow hole is positioned in a region defined by the partition wall; and
a third region that is a region that is not defined by the partition wall, and
wherein the main body plate is configured such that the first or second fluid flows from the first region to the second region via the third region.

16. The plate-type heat exchanger of claim 15, wherein the elongated protruding portions are symmetrically disposed in the first region so that intervals between the elongated protruding portions gradually decrease in the direction in which the first or second fluid flows, and
wherein the elongated protruding portions are symmetrically disposed in the second region so that intervals between the elongated protruding portions gradually increase in the direction in which the first or second fluid flows.
